(19) United States
(12) Patent Application Publication
(10) Pub. No.: US 2025/0324473 A1
(43) Pub. Date: Oct. 16, 2025

(54) METHOD FOR MANAGING NODES OF A WIRELESS COMMUNICATION NETWORK, METHOD FOR PROCESSING A REQUEST TO MODIFY A CONFIGURATION OF A CONNECTION BETWEEN NODES, CORRESPONDING DEVICES AND COMPUTER PROGRAMS

(71) Applicant: SAGEMCOM BROADBAND SAS, Bois-Colombes (FR)

(72) Inventor: Michael Thien Bao NGUYEN DINH HIEN, Bois-Colombes (FR)

(21) Appl. No.: 19/171,171

(22) Filed: Apr. 4, 2025

(30) Foreign Application Priority Data
Apr. 10, 2024 (FR) 2403704

(51) Int. Cl. H04W 76/15

(52) U.S. Cl. CPC H04W 76/15

(57) ABSTRACT

A method for managing a configuration of a plurality of nodes of a wireless communication network controlled by a controller node is disclosed that obtaining information relating to a control action on one of the frequency bands, scheduled to be executed by an executing node, transmitting, to an impacted node, of the plurality of nodes including the executing node, the impacted node having established at least one multi-link connection with at least one other node, a request to modify the configuration of the at least one connection, for a link of the multi-link connection using the frequency band, the configuration modification being a function of the control action; and upon receipt, from the impacted node, of a confirmation of configuration modification of the at least one connection, transmitting information to the controller node indicating that the scheduled control action on the frequency band is ready to be executed.

### CROSS REFERENCE TO RELATED APPLICATION

The present application claims priority to French App. No. 2403704 filed on Apr. 10, 2024 with the Intellectual Property Office of France, the entire disclosure of which is incorporated herein by reference.

### TECHNICAL FIELD

The invention relates to the technical field of wireless communication networks and, more specifically, to equipment, or access points, for accessing wireless communication networks, which are connected to each other by a plurality of links using distinct frequency bands. In particular, it concerns the adaptation of a configuration of a connection between two access points when a control action is to be carried out that is likely to disrupt communications on one or more of these frequency bands via this connection.

### STATE OF THE ART

The IEEE802.11be wireless communication standard, part of the IEEE802.11 family, standardized by the IEEE and adopted by the Wi-Fi Alliance as Wi-Fi 7, is known as a solution for connecting devices to each other on multiple different frequency bands at the same time, which are used together to transmit and receive data between these devices.

Also known is the EasyMesh standard, also standardized by the Wi-Fi alliance, a solution for deploying and managing a wireless mesh network linking together Wi-Fi access point devices that may be produced by different manufacturers. It is based on a set of transactions between these access points which form nodes of this mesh network, typically a controller node device and agent node devices. In this solution, the agent nodes register with the network controller node and are configured by it. The controller node benefits from a global view of the network, in that it knows both the configuration and status of every agent on the network.

As part of the management of such a wireless mesh network, the controller node is regularly called upon to trigger the execution of various control actions or procedures within one or more agent nodes, and more specifically one or more of the frequency bands they use to communicate with each other. These actions or procedures act on the node and on the connections it has established with other nodes.

Such actions are therefore likely to disrupt communications between node equipment, at various levels and with varying degrees of impact. Examples include, but are not limited to:
a procedure for frequency band scanning or Wi-Fi Scan, which is an operation performed by a device to search for and detect available Wi-Fi networks in its environment. When a device such as a smartphone, laptop, or tablet performs a Wi-Fi scan, it sends radio signals over the frequency band to detect nearby Wi-Fi networks. These radio signals enable the device to locate active WiFi networks, and to retrieve information on these networks, such as their name or SSID (Service Set Identifier), signal strength, channel, security mode, and so on. It is understood that during this frequency band scanning operation, the device cannot transmit or receive data on this frequency band. A complete scan over a wide frequency band may last several seconds.
a procedure to check the availability of a Wi-Fi channel or Wi-Fi CAC (Channel Availability Check), which is a specific feature of the Wi-Fi protocol, designed to help regulate competitive access to that transmission channel. By implementing this procedure, a Wi-Fi device can detect and monitor traffic on the channel in question, before transmitting data. This enables the device to ensure that there are no other transmissions in progress that could cause data collisions and disrupt communication. The Wi-Fi CAC procedure is particularly important in environments where several Wi-Fi devices operate in a confined space, such as in corporate wireless networks or densely populated areas. It helps avoid interference and maintain optimal network performance. One particular use of this Wi-Fi CAC procedure is in preparation for a channel change to a radar-protected channel. According to an official regulation covering part of the radar frequency band around 5 GHZ, any device wishing to use this part of the protected frequency band must first listen passively to any potential radar signal for at least one minute before transmitting its own radio signals, that is, implement the Wi-FI CAC procedure. It cannot transmit or receive during this period.
a Wi-Fi Sensing procedure, which consists of transmitting continuously over a period of time to analyze variations in the reception of data packets. This action uses standard Wi-Fi packets, but with a high sending frequency. In theory, it doesn't directly prevent the transmission or reception of other Wi-Fi data packets by the device performing the procedure, but because it saturates the radio channel, it is likely to disrupt the transmission or reception of certain types of data streams, particularly those associated with high latency and packet loss constraints, such as live data streams like video or voice. Moreover, this Wi-Fi Sensing procedure involves not only the agent node that triggers this action by transmitting data to another node on a given link of the connection it has established with it, but also this other node, which must respond to the data it has received from the agent node. The Wi-Fi sensing action therefore calls on two wireless network nodes simultaneously.

One drawback of these control actions on node access points of the mesh network is that they disrupt communications via the connections established between them, to varying degrees, with a greater or lesser impact on the quality of service experienced by users of the corresponding wireless communication networks.

### SUMMARY

The invention improves the situation. In particular, the invention is aimed at a solution for adapting at an earlier stage the configuration of agent nodes and of their connections with other agent nodes that are likely to be impacted by the execution of one of these control actions, in order to avoid or at least limit disruptions to their communications with these other nodes of the wireless communication network.

According to a first aspect, a method for managing a configuration of a plurality of nodes of a wireless communication network controlled by a controller node is proposed, said nodes of the plurality of nodes being configured to establish between them connections, called multi-links, comprising at least two links using at least two distinct frequency bands, said method, implemented by a device for managing a configuration of a plurality of nodes of a wireless communication network, integrated with the controller node or connected to it by a communication interface, comprising the steps of:
obtaining information relating to a control action on one of said frequency bands, scheduled to be executed by at least one said node, referred to as the executing node, and likely to disrupt communications on one or more multi-link connections established between the executing node and one or more other nodes of the wireless communication network;
triggering the transmission, by the controller node, to at least one node, referred to as the impacted node, of the plurality of nodes, said at least one impacted node comprising said at least one executing node, and at least one other node of the plurality of nodes, with which said at least one executing node has established at least one multi-link connection, of which at least one link, referred to as the impacted link, uses said frequency band on which the control action is scheduled, of a request to modify the configuration of said at least one connection, for the impacted link, said configuration modification being a function of said control action and comprising a command to remove authorization to transmit and receive data on said impacted link for at least one type of data stream; and
upon receipt, from said at least one impacted node, of a confirmation of configuration modification of said at least one connection, transmitting information to said controller node indicating that said scheduled control action on said frequency band is ready to be executed.

The proposed solution is based on a completely new and inventive approach to the control of agent nodes in a wireless network by a controller node, which consists in anticipating the disruptions caused by the execution of a control action on one or more nodes in the wireless network, by commanding them to modify the configuration of their multi-link connections which will be impacted by that control action, prior to the execution of that control action. One advantage is to exploit the controller node's native knowledge of the connections established by each of the wireless network's nodes and their status to coordinate a change in their multi-link connection configurations, before triggering the execution of the control action in question. Which configuration modification is commanded depends on the control action scheduled, and the nodes to which it applies depend on the wireless network configuration.

In this way, disruptions to communications between the agent nodes in question and other nodes are avoided or even minimized.

The invention applies to any wireless communication network whose nodes are access points that communicate with each other using (simultaneously) several links implementing distinct frequency bands. For example, the wireless network is a mesh network.

It applies particularly, but not exclusively, to a plurality of access points to Wi-Fi-type wireless communication networks implementing the IEEE802.11be standard, of the IEEE802.11 family, or Wi-Fi 7 or a later version thereof, linked together to form nodes of a mesh network controlled by a controller node, in accordance with the so-called EasyMesh standard, in its current version or a later version thereof.

According to one or more embodiments, the method further comprises the steps of:
obtaining a report on the execution of said control action on said frequency band, received by said controller node from said at least one executing node, and
transmitting said at least one impacted node a request to restore the configuration of said at least one connection.

Once the control action has been carried out, the controller node instructs at least one impacted node to restore its connection configurations. In this way, it returns its connections to the state they were in prior to the execution of the control action by the executing node.

Which configuration modification is commanded by the controller node to the agent nodes depends on the nature of the control action, and can range from the removal of data transmission and reception authorization on the frequency band affected by the control action for at least one given type of stream, to total removal, regardless of the type of stream. In the event of such a total or partial deletion, the other links in the connection will be used to transmit data from a stream of the at least one type affected. An advantage of this modification of the connection configuration of the agent nodes of the wireless communication network is that it is adapted proportionally to the control action.

According to one or more embodiments, the method comprises obtaining information relating to a type of configuration modification, at least as a function of the information relating to the control action and, when the information relating to a type of configuration modification comprises an interruption of data traffic on said impacted link, said command to remove authorization to transmit and receive data on said link affects all data stream types of the multi-link connection and, when the information relating to a type of configuration modification comprises a reduction in data traffic on said impacted link, said removal of authorization to transmit and receive data on said link does not affect all data stream types.

For example, for a control action such as scanning a given frequency band or checking the availability of a given frequency band, the configuration modification consists of completely interrupting traffic on the impacted link. On the other hand, for a control action such as the analysis of variations in data reception on a given frequency band (Wi-Fi sensing), data traffic can only be reduced by eliminating the use of the impacted link for certain data stream types.

For example, the type of stream affected by this elimination is a type of stream associated with strong latency constraints, such as a real-time video or voice stream.

According to one or more embodiments, the method further comprises obtaining a list of said nodes impacted by said control action, said list comprising said at least one executing node and at least one other node connected to said at least one node equipment by a multi-link connection comprising said impacted link, and in that the request for notification to modify the configuration of said link is issued to the impacted nodes of said list.

An advantage of the proposed solution is that it relies on knowledge of the impact of the scheduled control action on the nodes of the wireless communication network, to coordinate these nodes so that they no longer transmit data on the link using the frequency band that is the subject of the control action, or only on the types of stream that support the disruption generated.

According to one or more embodiments, the method further comprises the step of obtaining, from the plurality of nodes of said network, radio signal strength indications received from neighbor nodes, and in that the list of nodes impacted by said scheduled control action is determined at least from said received indications and from a minimum threshold of radio signal strength received.

For example, the controller node instructs the plurality of agent nodes in the wireless communication network to implement a neighbor report procedure, such as that defined by the IEEE 802.11k standard. In this way, an agent node listens to its neighbors and, for each radio signal detected, determines the radio signal strength received. The agent node compiles the information into a structured neighbor report, which it sends to the controller node.

The controller node then evaluates a range measurement for each node in the mesh network, based on the radio signal strength information received from the plurality of nodes and the minimum threshold of signal strength received. From this range measurement, it can determine which node is “visible” from which other node, and therefore which nodes in the mesh network will be impacted by the execution of a control action by the executing node.

In this way, the controller node simply and efficiently establishes the impact of the forthcoming control action.

According to a second aspect, a method of processing a request to modify a configuration of a node to a wireless communication network is proposed, said wireless communication network comprising a plurality of nodes, said nodes of the plurality of nodes being configured to establish between them so-called multi-link connections comprising at least two links using at least two distinct frequency bands, said wireless communication network being controlled by a controller node, said method comprising the steps of:
receiving a request to modify the configuration of a said at least one multi-link connection, established by the node with at least one other node of said wireless communication network, said request having been transmitted by a controller node of said wireless mesh network in accordance with the management method and received by said node from a controller node of said wireless mesh network, said request comprising a command to remove authorization to transmit and receive data on the link using a given frequency band, for at least one type of data stream,
triggering the transmission, by said node to said at least one other node, of a first request to renegotiate said connection, implementing said command to remove authorization to transmit and receive data on said link for said at least one connection, for the at least one type of data stream, and
following the renegotiation of said connection, triggering the transmission, by said node, of a message comprising a report on the execution of the modification to the configuration of the controller node.

With the proposed solution, any node in the wireless network is configured to reconfigure its connections with other access points, upon request from, and according to the terms prescribed by, the controller node. In this way, that node can trigger this reconfiguration ahead of the execution of an upcoming control action on that node or on another node in the wireless network to which the node is connected.

According to one or more embodiments, the method further comprises the steps of:
receiving a request to restore the configuration, from the controller node, said request comprising a command to add authorization to transmit and receive data on said link for said at least one connection, for said at least one type of stream,
triggering the transmission, by said node to said at least one other node, of a second request to renegotiate said at least one connection, implementing the command to add authorization to transmit and receive data on said link for said at least one connection, for said at least one type of stream, and
triggering the transmission by said node of a message comprising a report on the restoration of the configuration of said at least one connection.

Restoring the initial configuration is implemented in a similar way, allowing the node to regain the state of its connections with other access points prior to reconfiguration. Advantageously, this configuration restoration procedure takes place following execution of the control action by the node or by another node to which it is connected.

According to one or more embodiments, when said node is connected to a plurality of nodes by connections implementing a link using the given frequency band, said configuration modification request message is transmitted to said plurality of other nodes.

According to one or more embodiments, the first or second request to renegotiate said at least one connection comprises information indicating a list of authorized links for said at least one connection.

In this way, said list included in the first or second request replaces the previously applicable list of authorized links. Thus, the link to be removed for said at least one data stream is simply taken off the list in the first query and readded to the list in the second query.

According to a third aspect, a device for managing a configuration of a plurality of nodes of a wireless communication network controlled by a controller node is proposed, said nodes of the plurality of nodes being configured to establish so-called multi-link connections between them, comprising at least two links using at least two distinct frequency bands, said device being integrated into the controller node or connected to it by a communication interface, said device comprising at least said communication interface, a memory and a processor connected to said at least one communication interface and to the memory to control its operation and configured to:
obtain information relating to a control action on one of said frequency bands, said control action being scheduled to be executed by at least one node in said network, referred to as the executing node, and likely to disrupt communications on one or more multi-link connections established between the executing node and one or more other nodes of the wireless communication network;
trigger the transmission to at least one node, referred to as the impacted node, of the plurality of nodes, said at least one impacted node comprising said at least one executing node, and at least one other node of said plurality of nodes, with which the executing node has established at least one connection, of which at least one link, referred to as the impacted link, uses said frequency band on which the control action is scheduled, of a request to modify the configuration of said at least one connection, for the impacted link, said configuration modification being a function of said control action and comprising a command to remove authorization to transmit and receive data on said impacted link for at least one type of data stream; and
upon receipt, from said at least one impacted node, of a confirmation of configuration modification of said at least one connection, transmit information to said controller node indicating that said scheduled control action on said frequency band is ready to be executed.

According to at least one embodiment, said device comprises at least one processor and at least one memory comprising computer program code, the at least one memory and the computer program code being configured to, together with the at least one processor, cause the execution of said device.

According to at least one embodiment, such a device implements the management method according to the first aspect, in its various embodiments.

According to a fourth aspect, a device for processing a request to modify a configuration of a node of a wireless communication network comprising a plurality of nodes connected to each other by connections referred to as multi-link connections comprising at least two links using distinct frequency bands, said network being controlled by a controller node, said node having established at least one connection with another node of said network, said device being integrated with said node, said device comprising at least one communication interface, a memory, and a processor connected to said at least one communication interface and to the memory to control its operation and configured to:
receive a request to modify the configuration of at least one multi-link connection, for the link of said plurality of links using a given frequency band, transmitted by said management device from a controller node of said wireless mesh network, said request comprising a command to remove authorization to transmit and receive data on said link for said at least one connection, for at least one type of data stream,
trigger the transmission, by said node to said at least one other node, of a first request to renegotiate said connection, implementing said command to remove authorization to transmit and receive data on said link for said at least one connection, for at least one type of data stream, and
following the renegotiation of said connection, trigger a transmission, by said node, of a message comprising a report on the execution of the modification to the configuration of the controller node.

According to at least one embodiment, said aforementioned processing device comprises at least one processor and at least one memory comprising computer program code, the at least one memory and the computer program code being configured to, together with the at least one processor, cause the execution of said device.

According to at least one embodiment, such a device implements the processing method according to the second aspect, in its various embodiments.

According to a fifth aspect, a wireless communication network access point forming a node of a wireless communication network comprising a plurality of nodes is provided, said nodes of the plurality of nodes being configured to establish between them connections, referred to as multi-link connections, comprising at least two links using distinct frequency bands, said node having established at least one said multi-link connection, comprising at least two links using the at least two distinct frequency bands, the access point comprising a processing device according to the fourth aspect.

According to one or more embodiments, the access point according to is said to be an executing node and further configured to:
receive, from a controller node of said wireless communication network, a command to perform a control action on one of said frequency bands,
following execution of the control action, issue an action execution report to the controller node equipment.

According to a sixth aspect, a wireless communication network comprising a plurality of nodes is proposed, said nodes being access points according to the fifth aspect and at least one management device according to the third aspect.

The management device can be embedded in a control node equipment. The controller node can be one of the access points of nodes of the network. Alternatively, it can be distributed across the plurality of access points forming the nodes of the wireless communication network.

The wireless communication network, the access points, and the management device offer the same advantages as the aforementioned management method.

According to a seventh aspect, a computer program is proposed, comprising program instructions for executing a method according to the first aspect when said program is executed by a computer.

According to an eighth aspect, a non-volatile, computer-readable recording medium is proposed, on which the computer program according to the seventh aspect is recorded.

According to a ninth aspect, a computer program comprising program instructions for executing a method according to the second aspect when said program is executed by a computer.

According to a tenth aspect, a non-volatile, computer-readable recording medium is proposed, on which the computer program according to the ninth aspect is recorded.

### BRIEF DESCRIPTION OF THE DRAWINGS

Further features and advantages will become apparent from the following detailed description, which may be understood with reference to the attached drawings wherein:

FIG. 1 schematically shows a device for managing a plurality of nodes of a wireless network and devices for processing a request to modify a configuration of a multi-link connection between nodes of a wireless network, said nodes being access points to wireless communication networks, according to a particular non-limiting example;

FIG. 2 schematically shows an example of the paths taken by streams of data packets exchanged via a multi-link connection between two wireless network nodes;

FIG. 3 shows, in the form of a flowchart, the steps of a method for managing a plurality of nodes in a wireless communication network, according to a particular, non-limiting exemplary embodiment;

FIG. 4 details, in the form of a flowchart, the obtaining of a list of wireless network nodes impacted by a control action scheduled to be executed by a wireless network node, according to a particular, non-limiting exemplary embodiment;

FIG. 5 shows, in the form of a flowchart, the steps of a method for processing a request to modify the configuration of a multi-link connection established by a wireless network node with another node in this network, according to a particular, non-limiting exemplary embodiment;

FIG. 6 schematically shows an example of messages for renegotiating a multi-link connection between two wireless network nodes, according to one embodiment;

FIG. 7 shows the message streams exchanged between a controller node and a wireless network node to modify the configuration of a multi-link connection established by this node, prior to the execution of a scheduled control action of the Wi-Fi Scan type, according to a particular, non-limiting exemplary embodiment;

FIG. 8 schematically shows an example of the paths taken by streams of data packets exchanged via multi-link connections between nodes of the wireless network, after a modification to their configurations prior to the execution of a control action of the Wi-Fi Scan type on a given frequency band, according to a particular non-limiting example of implementation;

FIG. 9 schematically shows areas where nodes impact other nodes in a wireless network, according to a particular, non-limiting exemplary embodiment;

FIG. 10 shows the message streams exchanged between a controller node and agent nodes of a wireless network to modify the configuration of their respective multi-link connections, prior to the execution of a scheduled control action of the Wi-Fi Sensing type, according to a particular, non-limiting exemplary embodiment;

FIG. 11 schematically shows an example of the paths taken by streams of data packets exchanged via multi-link connections between nodes of the wireless network, after a modification to their configurations prior to the execution of a control action of the Wi-Fi Sensing type on a given frequency band, according to a particular non-limiting example of implementation;

FIG. 12A shows, by way of example, a table of values for a piece of information (TID-To-Link Mapping) indicating a list of authorized links for a multi-link connection;

FIG. 12B schematically shows an example of the nominal configuration of a multi-link connection, in which all types of traffic are permitted on all links;

FIG. 12C schematically shows an example of a modified configuration of a multi-link connection, in which certain types of traffic are not allowed on a given link;

FIG. 13 schematically shows an example of the hardware structure of a device for controlling or modifying a configuration according to one or more embodiments of the invention.

### DESCRIPTION OF EMBODIMENTS

In the following description, identical, similar or analogous elements will be referred to by the same reference numbers. Unless otherwise indicated, the diagrams are not necessarily to scale.

The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel.

The following exemplary embodiments are non-limiting and are based on networks that comply with the 802.11 family of standards of the Institute of Electrical and Electronics Engineers (IEEE), or so-called “WiFi” networks. Exemplary embodiments are based on the IEEE 802.11be amendment, in its version D4.0 or its version D5.0, or in subsequent versions or its final version. Other embodiments can also be based, for example, on an IEEE 802.11 standard version or an amendment to this 802.11 standard incorporating the IEEE 802.11be amendment, such as for example the IEEE 802.11bf D3.0 amendment or the IEEE 802.11bn amendment. They apply to both home and corporate wireless networks.

The following will relate in particular to access points, that is, hardware that enables stations, that is, devices, of the user terminal type, such as a laptop, smartphone, tablet, etc. or of the connected object or IoT (Internet of Things) type, to connect to the local communications network or LAN (Local Access Network), via a wireless connection. Such an access point creates a wireless LAN in a given area, providing radio coverage for nearby devices. It is usually connected to a WAN (Wide Access Network), for example a wired network, and acts as a gateway between devices and the wired network, enabling them to communicate with other devices connected to the WAN, and to access the Internet if the access point is connected to an Internet router.

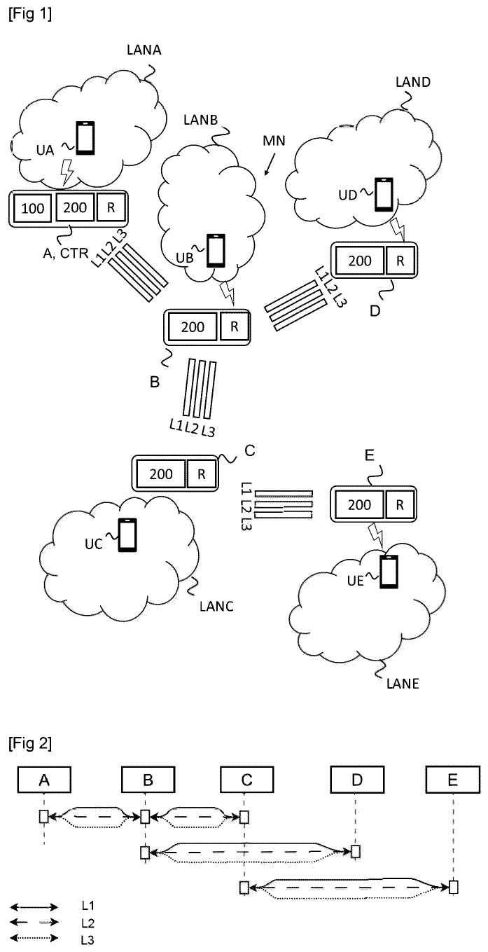

More precisely, in relation to FIG. 1, a plurality of access points connected together to form nodes of a wireless network MN is considered. In this example, the network has a mesh structure and forms a mesh network. Of course, other structures can be envisaged, such as a star-shaped arrangement.

In this example, an access point A on a wireless local area network LANA is connected via a MLO (Multi Link Operations) connection CAB to an access point B on a local area network LANB. This connection CAB comprises three links L1{A,B}, L2{A,B}, L3{A, B} each using one of the three distinct frequency bands defined by the Wi-Fi 6E protocol incorporating the IEEE 802.11ax-2021 amendment and Wi-Fi 7 incorporating the IEEE 802.11be amendment, respectively 2.4 GHZ, 5 GHZ and 6 GHz.

The IEEE 802.11be variant, also referred to hereafter as Wi-Fi7, defines the notion of a multi-link connection and messages for establishing and managing such a connection. The Wi-Fi7 standard makes it possible to establish a connection between two devices on a given frequency band, and then negotiate transmission modes on the other frequency bands shared by the two devices, so that they can transmit and receive data on the different frequency bands simultaneously. It also enables real-time negotiation of the frequency bands or links to be used to transmit and receive data via this connection.

In the example shown in FIG. 1, access point B is itself connected to access point C on a local area network LANC via a multi-link connection CBC, and to access point D on a local area network LAND via a multi-link connection CBD. Finally, the access point C is connected via a multi-link connection CDE to access point E on a local area network LANE.

Nodes C and D are connected to node B and have each negotiated a multi-link connection on the 3 frequency bands L1{B,C}, L2{B,C}, L3{B,C} and L1{B,D}, L2{B,D}, L3{B,D} respectively.

By way of purely illustrative example, we have shown a user terminal UA connected to the local area network LANA, a user terminal UB connected to the local area network LANB, a user terminal UC connected to the local area network LANC, a user terminal UD connected to the local area network LAND and a user terminal UE connected to the local area network LANE. User terminals UA-UE (or stations or STAs in the terminology of one of the IEEE 802.11 family of standards) are, for example, a smartphone, computer, tablet or connected object.

The wireless mesh network MN, for example, is built according to the EasyMesh standard, which describes the mechanisms and messages that enable its nodes to coordinate with each other. More precisely, the mesh network MN is built through the configuration of a controller node (not shown in FIG. 1) configured to control the configuration of nodes A-E of the wireless network MN. Note that the controller node is generally an access point just like the other nodes A-E.

Thus, in the mesh network MN shown in FIG. 1, each node A-E implements the Wi-Fi7 standard on the three frequency bands 2.4 GHZ, 5 GHZ and 6 GHZ, as well as the EasyMesh standard (e.g. versions or revisions 5.0, and later ones compatible with previous ones) to build and manage the mesh network MN. For example, the EasyMesh standard is implemented on each node of the mesh network using a software program called an agent.

In relation to FIG. 2, nodes C and D communicate with node A through node B on the 3 links of their respective connections. In FIG. 2, the packet streams exchanged on different paths between nodes A-E are represented by arrows. Solid arrows indicate links L1 using the 2.4G Hz frequency band, dashed arrows indicate links L2 using the 5 GHz frequency band, and dotted arrows indicate links L3 using the 6 GHz frequency band.

The streams f1 of data packets exchanged between A and C over the link L1 take the following path:

A←→C(f1):L1{A,B}+L1{B,C}.

Similarly, node E communicates with node A via nodes B and C. Thus, the set of streams f1, f2, f3 is written as follows:
Between A and C:

A←→C(f1):L1{A,B}+L1{B,C}

A←→C(f2):L2{A,B}+L2{B,C}

A←→C(f3):L3{A,B}+L3{B,C}
Between A and D:

A←→D(f1):L1{A,B}+L1{B,D}

A←→D(f2):L2{A,B}+L2{B,D}

A←→D(f3):L3{A,B}(3)+L3{B,D}
Between A and E:

A←→E(f1):L1{A,B}+L1{B,C}+L1{C,E}

A←→AE(f2):L2{A,B}+L2{B,C}+L2{C,E}

A←→E(f3):L3{A,B}+L3{B,C}+L3{C,E}

The controller node CTR in FIG. 1 is configured to program and trigger a control action on any node(s) in the mesh network MN, including itself. For example, this control action is one of the previously described procedures comprising:
the frequency band scanning or Wi-Fi Scan procedure,
the procedure for checking the availability of a Wi-Fi channel or Wi-Fi CAC, and
the Wi-Fi Sensing procedure.

In the following, we refer to the node(s) designated to execute the control action in question as the executing node(s).

Such a control action is likely to cause disruptions of varying degrees of severity to the stream of data packets exchanged over the connections established by the executing node with other nodes in the mesh network, with negative consequences on the quality of service perceived by users of the wireless communications networks of the node and of the other impacted nodes.

In the following, devices and methods are presented for controlling and modifying a configuration of connections established by the executing node with other nodes of this MN wireless mesh network, prior to the implementation by this executing node of an action to control a frequency band likely to generate disruptions on the streams of data packets exchanged by the node on the links of the connections established by this node using this frequency band. These devices and methods make it possible to anticipate disruptions by adapting the configurations of the affected connections at an earlier stage.

According to one or more embodiments, the controller node CTR comprises a device 100 for managing a plurality of nodes of a wireless network, such as that shown in FIG. 1, the nodes of which are access points to wireless communication networks. Such a device is configured to:
obtain information about the control action to be executed on one of said frequency bands by the at least one executing node,
trigger the transmission by the controller node, to at least one node, referred to as the impacted node, of the plurality of nodes, comprising said at least one executing node, said impacted node having established at least one multi-link connection with at least one other node of said plurality of nodes, said at least one connection comprising at least two links using distinct frequency bands, of which one link, referred to as the impacted link, uses said frequency band on which the control action is to be executed, of a request to modify the configuration of said at least one multi-link connection, for the impacted link, said configuration modification being a function of said control action, and,
upon receipt by the controller node, from said at least one impacted node, of a confirmation of configuration modification of said at least one connection, transmit information to said controller node indicating that said control action on said frequency band is ready to be executed.

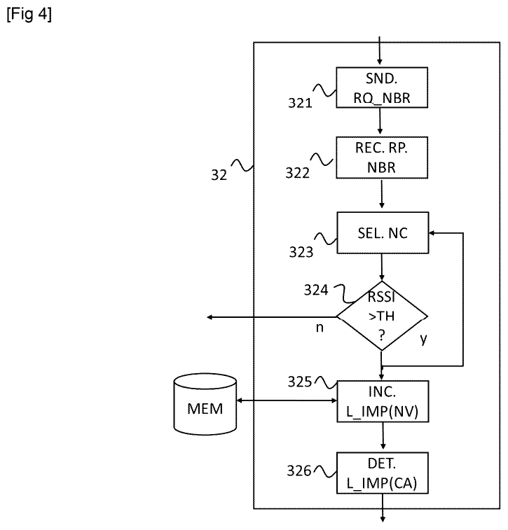

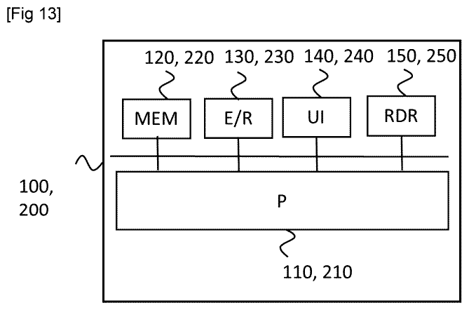

Thus, according to one or more embodiments, the device 100 implements a method for managing a plurality of nodes in a wireless network, which will be described below in relation to FIG. 4. The device 100 can be implemented in a variety of software and/or hardware ways. An example of the hardware structure of the device 100 will be described below in relation to FIG. 13.

According to one or more embodiments, each node of the mesh network MN comprises a device 200 for processing a request to modify a configuration of a node of a wireless network, said node having established at least one multi-link connection with at least one other node of said network, said device being configured to:
obtain a request to modify the configuration of at least one connection, for the multi-link connection link that uses a given frequency band, received by said node, from the controller node of said wireless mesh network, said notification comprising a command to remove authorization to transmit and receive data on said link for said at least one connection, for at least one type of data stream,
trigger the transmission, by said node to said at least one other node, of a first request to renegotiate said connection, implementing said command to remove authorization to transmit and receive data on said link for said at least one connection, for the at least one type of data stream, and
following the renegotiation of said connection, trigger the transmission, by said node, of a message comprising a report on the execution of the modification to the configuration of the controller node.

Thus, according to one or more embodiments, the device 200 implements a method for processing a modification to a connection configuration which will be described below in relation to FIG. 5. The device 200 can be implemented in a variety of software and/or hardware ways. An example of the hardware structure of the device 200 will be described below in relation to FIG. 13.

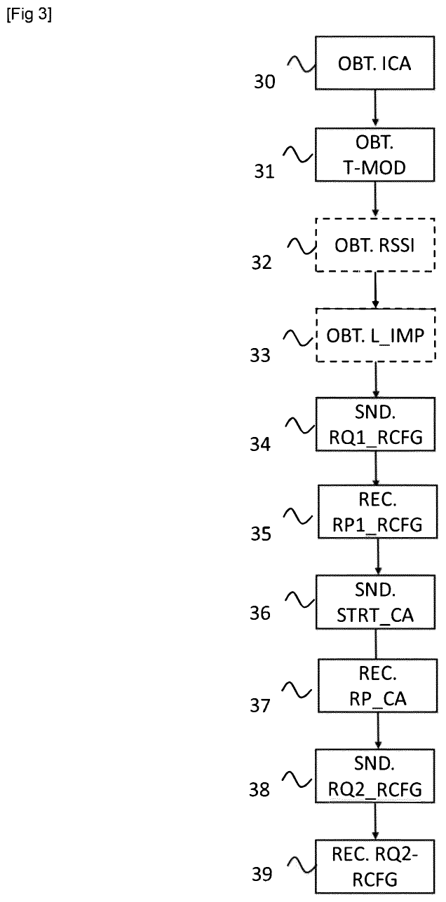

Referring now to FIG. 3, a method for managing a plurality of nodes in a wireless communication network is presented. In the following, it is assumed that the method is implemented by a device integrated into a controller node, which can be any of the nodes in the mesh network. The controller node differs from the other nodes in that it is equipped with controller features as specified, for example, by the EasyMesh standard, while the other nodes are equipped by the same standard with features for executing controller node commands. In both cases, these functions can be implemented in the node in the form of a computer program, called an agent.

In the following, for example, we consider the controller node CTR in FIG. 1, which corresponds to access point A.

In a step 30, the 100 device of the controller node CTR obtains information ICA relating to a control action CA scheduled by the controller node to be executed on a given frequency band by at least one node of the mesh network MN, known as the executing node. This information ICA includes at least one identifier of the control action CA and an identifier of the node or nodes that are to execute it. Optionally, it can also include additional information elements relating, for example, to a type of disruption caused by executing this control action on the connection(s) established by the node with other nodes in the mesh network.

In a step 31, the device 100 obtains information T_MOD relating to a type of configuration modification, at least as a function of information ICA relating to the control action.

Depending on the control action CA to be performed, the type of configuration modification comprises an interruption of data traffic on said impacted link or a reduction of data traffic on said impacted link, said removal of authorization for data transmission and reception on said link does not concern all types of data stream.

According to one or more embodiments, the information T_MOD relating to a type of modification is included in the information ICA as an additional piece of information. Alternatively, it can be obtained from all or part of the information ICA, e.g. the control action identifier CA, which can then be used as a search index to access additional information elements stored in a memory, e.g. of the device 100 or the controller node CTR.

Depending on the control action CA scheduled to be executed, nodes other than the executing node(s) may be impacted. Optionally, in a step 33, the device 100 obtains, at least from the information ICA obtained, a list L_IMP of nodes in the mesh network that will be impacted by the execution of the control action CA at the executing node. This list comprises at least the executing node.

According to one or more embodiments, this list L_IMP is obtained from radio signal strength information RSSI received by the plurality of nodes in the mesh network from the other nodes and a given minimum level threshold TH. This information RSSI is obtained in 32 by the device 100. For example, it reads them from a memory where they have been previously stored, or receives them from some of the wireless network MN nodes on request.

This second option takes into account the current state of the network MN and is shown in FIG. 4. The device 100 triggers the controller node CTR to send a neighbor report request in 321 to certain nodes in the plurality of nodes in the mesh network MN.

This neighbor report request instructs the node receiving it to listen to a given frequency band, typically the one concerned by the scheduled control action, and to determine, for each radio signal detected, a received signal strength indication (RSSI). For example, the node implements a neighbor report procedure as specified by IEEE 802.11k-2008, which enables a Wi-Fi access point (AP) to collect information about neighboring APs and works as follows:
The node sends a neighbor request to other neighbor APs to obtain information about their networks and capacities,
The neighbor nodes respond to the request in a neighbor response, which includes information about their identity and capacity, including the different frequency bands they are able to use,
The node listens to the given frequency band and determines information RSSI for each radio signal received from another access point, typically a beacon frame,
The node compiles the information received into a structured neighbor report. This report is then transmitted to the requesting node, in this case the controller node, using a message conforming to the EasyMesh protocol, for example.

The device 100 obtains the neighbor reports received by the controller node from the relevant nodes of the network MN in 322.

The device 100 is configured to use information RSSI received from one of the plurality of access point nodes to determine a range measurement for each of them. To do this, in 323 it selects a current node NC and for each of the indications RSSI contained in its neighbor report, in 324 it uses a given threshold TH, for example set at-75 dBm and compares the value of that the radio signal strength indication RSSI received from a neighbor node NV by the current node NC with the threshold TH. If the signal strength indication received from the neighbor node NV is greater than the given threshold TH, it assumes that a transmission from the neighbor node is occupying the current node's radio medium and therefore that the current node is within range of the neighbor node. In other words, if the neighbor node NV performs a control action on the frequency band, the current node NC will potentially be impacted.

The device 100 then adds the current node NV to an impact list L_IMP (NV) of the neighbor node. Otherwise, when the indication RSSI is less than or equal to the threshold TH, it considers that the neighbor node is not “visible” to the current node and switches to the indication RSSI received from another neighbor node by the current node. It repeats the operation for all indications RSSI in the current node's neighbor report.

Once the current node's neighbor report has been processed, it moves on to the next node and repeats the operations described above, until the plurality of nodes has been processed.

This analysis enables it to build an impact list for each node of the plurality of nodes. In 326, it merges the impact lists associated with the executing node(s) and obtains the L_IMP (CA) list of nodes impacted by the scheduled control action CA.

In a step 34, the device 100 sends a message to the impacted node(s) in the L_IMP list, including a first notification or request RQ1_RCFG to modify the configuration of its connection(s) with other nodes comprising a link that uses the given frequency band, referred to as the impacted link.

This message can be sent on one or more links of the multi-link connection(s). One advantage of sending it on all links is that it increases the chances of it being received by the destination node.

Which configuration modification is requested depends on the control action, and in particular on the type of disruption it is likely to cause. According to one or more embodiments, the configuration modification request is built from the modification type T_MOD obtained in 31.

In particular, when the type of configuration modification T_MOD comprises a reduction of the connection on the impacted link, the request to modify the configuration of said at least one connection comprises a notification of removal of an authorization to transmit and receive data on said impacted link for at least one type of data stream.

Conversely, when the type of configuration modification T_MOD comprises an interruption of the connection on the impacted link, the request to modify the configuration of said at least one connection comprises a notification of removal of an authorization to transmit and receive data on said impacted link for all types of data streams.

For example, for a control action CA such as scanning a given frequency band (Wi-Fi Scan) or checking the availability of a given frequency band (Wi-Fi CAC), the configuration modification consists of completely interrupting traffic on the impacted link. On the other hand, for a control action such as the analysis of variations in data reception on a given frequency band (Wi-Fi sensing), data traffic can only be reduced by eliminating the use of the impacted link for certain data stream types.

For example, the type of stream affected by this elimination is a type of stream associated with strong latency constraints, such as a real-time video or voice stream.

In a step 35, the device 100 receives a message RP1_RCFG from the affected node(s), acknowledging the requested configuration modification and comprising, for example, an execution report.

In a step 36, the device 100 informs the controller node, for example by sending a message STRT-CA, that the required configuration modifications have been made and that it can trigger the execution of the control action CA on said frequency band.

In a step 37, it obtains from the control node CTR END_CA information about the end of execution of the control action by the executing node(s), e.g. it obtains a message comprising, for example, a report on the execution of the control action CA received by the controller node from the executing node.

In 38, the device 100 triggers the controller node to send a message comprising a second configuration modification request or notification RQ2_RCFG to the affected nodes. It comprises a request to restore the configuration of said at least one connection. Likewise, this message can be sent on one or more links of the multi-link connection(s). One advantage of sending it on all links is that it increases the chances of it being received by the destination node.

In a step 39, the device 100 obtains a second configuration modification acknowledgment message RP2_RCFG, received by the controller node from the impacted node(s) and comprising, for example, a report on the execution of the requested configuration restoration.

The method described above enables a controller node to synchronize a renegotiation by the node(s) of the multi-link connections that will be impacted by the execution of the control action CA. To do so, in one or more embodiments, the device 100 relies on messages whose format is specified by the EasyMesh standard.

According to one or more embodiments, the configuration modification notification message RQ1_RCFG can be a single message sent to all impacted nodes, to which each of the impacted nodes responds with a configuration modification acknowledgment message RP1_RCFG.

For example, it is an IEEE1905-type reconfiguration transaction comprising a request message containing information about a list of multi-link connections to be reconfigured, and a response message sent after the configuration has been applied by each of the nodes affected. Such a transaction is described in the EasyMesh R6 specification, section 7.4 of the draft 6th revision of the EasyMesh Wi-Fi specification_EasyMesh_Specification_DRAFT_R6-240208b. For example, this EasyMesh reconfiguration transaction is constructed as follows:
An “AP MLD Configuration Request message” (specified in the EasyMesh R6 Specification, Section 17.1.63), and
An “AP MLD Configuration Response message” (specified in the EasyMesh R6 Specification, Section 17.1.64).

The “AP MLD Configuration Request message” comprises a TLV information field entitled “Agent AP MLD Configuration TLV” (specified in the EasyMesh R6 Specification, Section 17.2.96). More generally, a TLV information field contains “Type, Length, Value” information, whereby “Type” designates a type of information or parameter included in the field, “Length” indicates the length of the field, specified in bytes or bits, and “Value” contains the actual data associated with the specified type. One advantage of a TLV information field is that it allows new types of information to be added without requiring major changes to the underlying standard or protocol.

More specifically, the “Agent AP MLD Configuration TLV” field describes connection configuration parameters, in particular the links allowed to transport data packet streams. These parameters are detailed below.

More specifically and in relation to FIG. 4, the TLV information field “Agent AP MLD Configuration” comprises the following elements:
a list of multi-link connections or Multi-Link Description (MLD), the number of which is given by the “Value” field entitled ‘Number of MLD’.
For each multi-link connection, the MLD element includes the following information fields:
a Wi-Fi network SSID,
a MAC address dedicated to this multi-link connection,
a list of access points, the number of which is given by the ‘Num

Affiliated APs’ field. For each access point in this list, the “Agent AP MLD Configuration” information field comprises an EasyMesh standard description of this access point, including an AP MAC Address, a Radio Unique Identifier (RUID), a link-ID identifier for the link in the multi-link connection

The device 100 sends this message to notify the nodes of the mesh network identified as impacted by the control action CA, of the new configuration to be adopted. This message indicates the multi-link connections concerned and their composition.

Once the configuration change has been made, each affected node replies to the controller node with a response message. This message has two functions, the first being to acknowledge the configuration change, and the second to update the configuration information of the multi-link connections at the controller node.

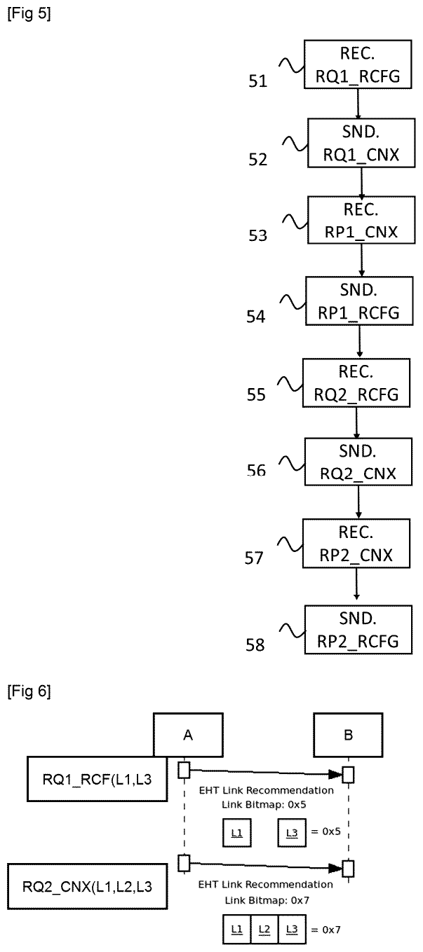

The “AP MLD Configuration Response message” comprises the “Agent AP MLD Configuration TLV” TLV information field detailed above, wherein for each multi-link connection, the node affected has filled in the AP MAC Address, RUID and Link_ID information fields, and another TLV information field called “EHT Operations TLV” (specified in the EasyMesh R6 specification, Section 17.2.103), whose content corresponds to that of the Wi-Fi7 configuration and will be detailed below in relation to FIG. 6.

In relation to FIG. 5, a method is now described for processing a request to modify a configuration of a multi-link connection established by a node of a wireless network, according to one or more embodiments. In what follows, it is assumed that the method in question is implemented by a device 200 as described above, in relation to FIG. 1. Such a device 200 is embedded in a node of the wireless network, for example an access point of the mesh network MN of FIG. 1, being part of the nodes identified as likely to be impacted by the control action scheduled to be executed by said at least one node executing on a given frequency band. This impacted node can therefore be the node or one of the executing nodes or another node, depending on the scheduled control action.

In the following, it is assumed that this impacted node has established at least one multi-link connection with at least one other node in the wireless network.

In a step 51, the device 200 obtains a request message RQ1_RCFG to modify the configuration of at least one multi-link connection established by said impacted node, received by said node from the controller node CTR of said wireless mesh network. This message can be received on one or more links of the multi-link connection(s).

According to one or more embodiments, this request comprises a command to delete an authorization to transmit and receive data on the link of said connection using the frequency band affected by the link control action for said at least one connection, for at least one type of data stream,

In 52, the device 200 sends to said other node a message comprising a first request RQ1-CNX to renegotiate said connection, comprising configuration instructions implementing the command to remove authorization to transmit and receive data on said link for said at least one connection, for said at least one type of stream.

According to one or more embodiments modes, these configuration instructions specify, for said at least one connection, the links allowed for transmitting and receiving data streams, and therefore do not comprise said link for said at least one data stream.

For example, the configuration instructions are specified using an information field entitled “TID-To-Link Mapping” to specify which links are to be used for the multi-link connection. For example, the TID-To-Link Mapping field indicates an ordered binary sequence (“bitmap”) wherein each bit corresponds to a link in the multi-link connection, the corresponding link being authorized when the bit is 1 and prohibited when it is 0.

Following the renegotiation of said connection, the device 200 sends a response message RP1-CNX in 53 from the affected node, comprising a report on the configuration modification to the controller node.

In 54, the device 200 obtains a configuration restoration request message received by the impacted node from the controller node, comprising a command to add data transmission and reception authorization on said link for said at least one connection, for said at least one stream type.

In 55, the device 200 triggers the transmission by the impacted node to the other node to which it is connected via said connection, of a message comprising a second request RQ2_CNX to renegotiate said at least one connection, comprising configuration instructions, implementing the command to add an authorization to transmit and receive data on said link for said at least one connection, for said at least one type of stream.

According to one or more embodiments modes, these configuration instructions specify, for said at least one connection, the links allowed for transmitting and receiving data streams, and comprise said link for said at least one type of stream.

In 56, the device 200 triggers the transmission of a message RP2_RCFG from the impacted node to the controller node, comprising a report on the restoration of the configuration of said at least one connection.

According to one or more embodiments, when said impacted node has established multiple of connections implementing a link using the given frequency band, the successive first connection renegotiation request messages RQ1_CNX and the second connection renegotiation request message RQ2_CNX are sent to said plurality of other nodes connected to it via these connections.

In this way, each of the impacted nodes renegotiates the multi-link connections it has established with other nodes to adapt their configurations on request from the controller node, before executing the scheduled control action on the given frequency band, and then a second time, once the control action has been completed, upon request from the controller, to restore the initial configurations.

According to one or more embodiments, the connection renegotiation request messages comply with the Wi-Fi7 standard, in particular IEEE802.11be Draft 4.0 § 35.3.7 Link management.

According to this section, when negotiating a multi-link connection with a station equipment that wishes to attach to it, an access point can define information relating to one or more types of stream authorized on each of the links of this connection. This information is described in a “beacon” frame which is periodically transmitted in the LAN to announce its capabilities, particularly in terms of QoS, and which is listened to by stations and other access points. The information obtained enables a station to determine which Wi-Fi networks are available and decide which access point to connect to. The management frame comprises other essential information about the local network, such as the network's SSID (Service Set Identifier), security capabilities, supported channels, timeouts, etc. For another access point, this information makes it possible to know which neighboring access points are visible through the radio medium, and thus to coordinate using the EasyMesh protocol.

This information about the types of streams allowed on a given link is also described in another management frame, called a probe response, sent by an access point (AP) in response to a probe request sent by a station wishing to connect to the access point. The poll response includes other essential information about the access point's local network, such as its SSID name, security capabilities, etc., to enable the requesting station to decide whether to associate itself with this “access point”.

This information is also exchanged when a station is associated with the access point. Finally, it can be sent by the access point to the stations connected to it to renegotiate the connection, modifying the types of stream authorized on the link.

In all cases, a piece of information called TID-To-Link Mapping describes the association of a traffic identifier (TID), which identifies a specific data stream or type of traffic, with a link in the multi-link connection.

In this respect, a Traffic Identifier is any identifier that can be used by upper layer entities to distinguish Media Access Control (MAC) Service Data Units (MSDUs) from MAC entities that support Quality of Service (QOS) within the MAC data service.

There are 16 possible values for the traffic identifier, 8 of which identify Traffic Categories (TC) distinguishing between Voice, Video, Best Effort and Background, each of which has specific Quality of Service (QOS) requirements in terms of delay, jitter, packet loss and so on.

The other 8 possible values identify parameterized traffic streams (TS), that is, specific types of data stream in a Wi-Fi network that are associated with specific transmission parameters. These data streams are characterized by parameters such as bitrate, transmission delays, bandwidth requirements, etc., which are used to provide Quality of Service (QOS) guarantees for delay-sensitive applications such as Voice over IP (VOIP) or video streaming. They can be combined with QoS management mechanisms such as WMM (Wi-Fi Multimedia) as part of the IEEE 802.11e standard.

The traffic identifier TID is assigned to an MSDU in the layers of the OSI model above the MAC layer. This ensures correspondence between the IP layer (TOS/DSCP field) and the Wi-Fi MAC layer (TID) in order to manage transmission. Once the packet has been categorized, the information is integrated into the Wi-Fi header. This allows the Wi-Fi protocol to treat a category of stream independently once it has been identified and tagged with the TID associated with the traffic type.

More specifically, according to the IEEE802.11be 9.4.2.314 TID amendment, the TID-To-Link Mapping takes the form of a TLV information element, whose “Value” information field indicates, for each link of the multi-link connection, the types of traffic that can pass through that link. If no traffic type is defined for a link, it is considered no longer usable. By default, all traffic types are allowed on all links.

According to one or more embodiments, this TID-To-Link Mapping information element is used in connection renegotiation request messages RQ1_CNX and RQ2_CNX sent by the mesh nodes affected by the scheduled control action CA, to respond to requests to modify the configuration of their connections received from the controller node.

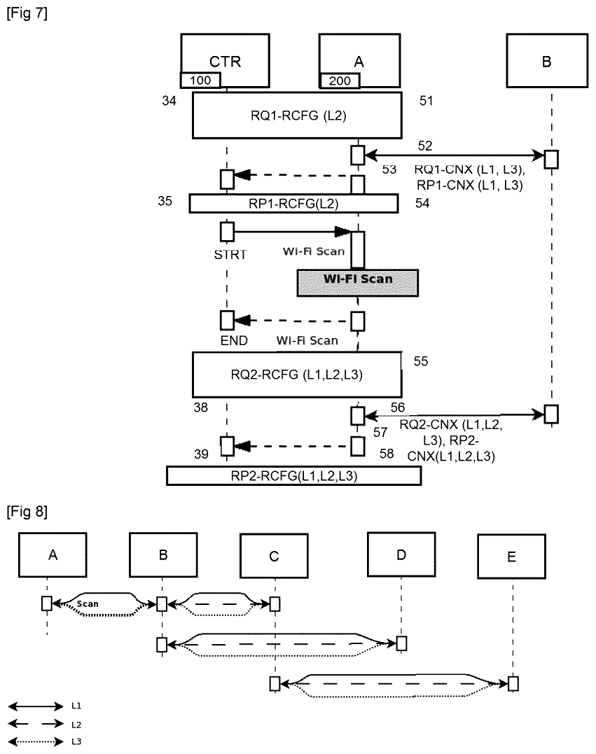

In relation to FIGS. 6 and 7, we now detail an example of the implementation of the renegotiation mechanism of a multi-link connection, according to one or more embodiments. In particular, we consider the case of a total interruption of transmission and reception on the link using the frequency band affected by the scheduled control action.

For example, the device 200 is configured to transmit this TID-To-Link Mapping field in an Action Frame, as defined for example in IEEE 802.11be Draft 4.0, an “Action Frame”. According to one embodiment, this is a particular type of control frame used by one node of a Wi-Fi wireless network to trigger a specific action on the part of another node.

For example, in relation to FIG. 6, the action frame used is a recommendation concerning link parameters for communications in a Wi-Fi network operating in “Extended High Throughput” (EHT) mode. The renegotiation message for the connection RQ1_CNX then takes the following form:
IEE 802.11 Action No Ack, Flags: . . . . C
IEE 802.11 Wireless Management
Fixed parameters
Category code: Protected EHT (37)

### Protected EHT Action: EHT Link Recommendation (7)

Reason code: Unspecified Reason (0x0001)
Ext Tag: AID Bitmap (702.11be D3.0)
Ext Tag length: 3 (Tag len 4)
Ext Tag Number: AID Bitmap (802.11be D3.0) (134)
Partial AID Bitmap Length: 1
Bitmap Control: 0x44.
. . . 0=Reserved 0x0
0100 010.=Bitmap offset 0x22
Partial AID Bitmap: 01
Association ID: 0x0220
Ext Tag: Multi-Link Traffic Indication (802.11 be D3.0)
Ext Tag length: 3 (Tag len: 4)
Ext Tag Number: Multi-Link Traffic Indication (802.11be D3.0 (110)
Multi-Link Traffic Control: 0x2202, Bitmap Size: 3
. . . 0010=Bitmap Size: 3.
010 0010 0000 . . . =AID Offset: 544
0 . . . =Reserved: 0x0

### Traffic Indication List: 05

Tagged parameters (18 bytes)
Renegotiation and addition of the L2 link:

The line “Protected EHT Action: EHT Link Recommendation (7)” indicates that the message is of the “link recommendation” type.

The line “Traffic Indication List: 07” describes the composition of links using a bit mask of authorized links. In binary, 0x5 is 101, which corresponds to L1=1, L2=0, L3=1. The link L2 is therefore not authorized for the connection.

Once the control action has been completed, each impacted node transmits, on receipt of a configuration restoration request RQ2_RCFG from the controller node, a second renegotiation request RQ2_CNX with the other node(s) with which it has established a multi-link connection to re-authorize the temporarily forbidden link.

In the example shown in FIG. 6, the configuration restoration instructions are transmitted in a link recommendation action frame in extended high-speed mode EHT, and the “Traffic Indication List” parameter is set to 0x7 this time. In binary, this value corresponds to the binary sequence 111, indicating L1=1, L2=1, L3=1. Once this configuration change has been implemented, all links in the multi-link connection between the nodes A and B are enabled again.

Referring to FIG. 7, we now describe an example of how to implement the methods just described in the case where the scheduled control action is a Wi-Fi Scan procedure for analyzing or scanning a given one of the available frequency bands. With reference to FIG. 1, it is assumed that the controller node CTR has scheduled the execution of this Wi-Fi Scan control action on one of the 5 GHz frequency bands, for example the low band 5150 MHz-5350 MHz. In the example shown in FIG. 1, the controller node CTR and node A are one and the same access point. However, the following description applies equally well when the two nodes are separate access points.

The impact of a Wi-Fi Scan control action on the CAB multi-link connection set up by executing node A is defined as an interruption of transmission and reception on the link using the given frequency band for the duration of the scan, which is approximately 20 seconds.

Only the executing node will be prevented from transmitting and receiving on this link. It is therefore the only node in the mesh network affected by the execution of this control action.

In this example, considering node A, the Wi-Fi Scan control action will have an impact on the link L2{A,B} of the connection CAB, which uses the 5 GHz frequency band.

For this Wi-Fi Scan control action, the proposed solution is to renegotiate the multi-link connection to remove the L2 link from the connection CAB.

Referring to FIG. 7, the device 100 of controller node CTR obtains information ICA in 30 relating to the programming of a Wi-Fi Scan control action ICA on node A of the wireless network MN that it controls. It notifies node A by sending it a request RQ1_RCFG in 34 to modify the configuration of its connection CAB. It indicates that the authorization to transmit and receive on the L2 link should be removed. The device 200 of node A receives this request and triggers a renegotiation of its connection CAB with node B by sending it a connection renegotiation request RQ1_CNX in 52, wherein data transmission and reception on link L2 are not (any longer) allowed, regardless of the type of data traffic.

For example, node B chooses, according to a proprietary decision logic, to use the authorized link L3 instead of the deleted link L2.

On receiving a response message RP1_CNX from node B, node A's device 200 confirms in 53 to the controller node CTR that the connection has been renegotiated (RP1_RCFG). On receipt, the controller device 100 notifies (STRT WI-FI SCAN) in 36 the controller node that it can trigger the Wi-Fi Scan control action.

With reference to FIG. 8, following this first renegotiation of the multi-link connection CAB, the impact on the previously defined data packet streams is as follows:
Between A and C:

A←→C(f1):L1{A,B}+L{B,C}

A←→C(f2):L3{A,B}+L2{B,C}

A←→C(f3):L3{A,B}+L3{B,C}
Between A and D:

A←→D(f1):L1{A,B}+L1{B,D}

A←→D(f2):L3{A,B}+L2{B,D}

A←→D(f3):L3{A,B}+L3{B,D}
Between A and E:

A←→E(f1):L1{A,B}+L1{B,C}+L1{C,E}

A←→E(f2):L3{A,B}+L2{B,C}+L2{C,E}

A←→E(f3):L3{A,B}+L3{B,C}+L3{C,E}

The controller node CTR triggers the Wi-Fi Scan action by sending a command RQ_CA to node A, which performs the Wi-Fi Scan for 20 seconds and then transmits a Wi-Fi Scan execution report RP_CA to the controller node. As soon as it is informed (END Wi-Fi SCAN), the device 100 of the controller node CTR notifies node A by sending it a request RQ2_RCFG in 38 to restore the configuration of its connection CAB. It indicates that the authorization to transmit and receive on the L2 link, previously removed, should be added. The device 200 of node A receives this request in 54 and triggers a renegotiation of its connection CAB with node B by sending it a connection renegotiation request RQ2_CNX in 55, wherein data transmission and reception on link L2 is once again allowed, regardless of the type of data traffic. On receiving confirmation from node B in 56, the device 200 of node A confirms to the controller node in 57 that the initial configuration for the connection CAB has been restored.

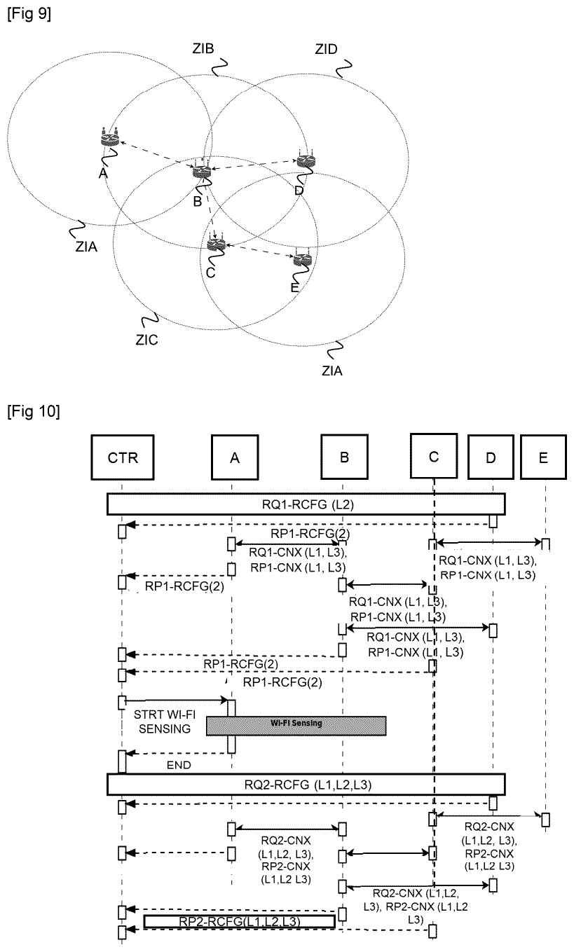

Referring to FIGS. 9-11, we now describe an example of how to implement the methods just described in the case where the scheduled control action is a Wi-Fi Sensing procedure for detecting the receipt of data packets on a given one of the available frequency bands. With reference to FIG. 1, it is assumed that the controller node CTR has scheduled the execution of this Wi-Fi Sensing control action on the 5 GHz frequency band between nodes A and B, both of which are considered to be executing nodes in the following, even though A is designated to initiate the Wi-Fi Sensing procedure and B only reacts. In the example shown in FIG. 1, the controller node CTR and node A are one and the same access point. However, the following description applies equally well when the three nodes CTR, A, and B are separate access points.

The action is based on an exchange of packets at short intervals between node A and node B qu. The duration of disruption is estimated at 10 seconds. The impact of a Wi-Fi Sensing control action can be defined as a significant reduction in transmission and reception on the links L2 using the 5 GHz frequency band of all connections established by the two nodes A and B for the duration of the data packet exchange.

The impact study for this Wi-Fi Sensing action is therefore potentially more complex than the one for the Wi-Fi Scan action. More precisely, as nodes A and B will each transmit and receive data packets on the 5 GHz frequency band to perform the Wi-Fi Sensing action, we can define as the impact zone all the nodes in the mesh network that use this 5 GHz frequency band and are close enough to nodes A and B to be affected by this packet exchange, that is, to detect the resulting radio signals. For example, the proximity of one node to another can be deduced from a received signal strength indication (RSSI) provided by the node in question to the other node, and comparison with a given threshold TH, for example set at −75 dBm, as previously described in relation to FIG. 4. In this case, nodes in the mesh network MB that have indicated received signal strength indication RSSI above the given threshold TH are considered to be impacted by the scheduled Wi-Fi Sensing control action.

According to one or more embodiments, this impact study is implemented by the device 100 of the controller node CTR.

The latter can retrieve and aggregate information on signal strength RSSI received by each node from each other node in the mesh network MN, for example by triggering at each node of the plurality of nodes in the mesh network, the implementation of a neighbor reporting procedure as specified in the IEEE 802.11k standard.

By way of an illustrative and non-limiting example, one may consider setting a minimum radio signal strength threshold TH at −75 dBm. Thus, for a given node, all its “visible” neighbors at more than TH=−75 dBm, that is, whose radio signals the node receives with a radio signal strength above the threshold TH, are considered to impact it. In other examples, the given threshold TH is chosen from a range of values, for example, between −70 dBm and −80 dBm. This value can be configured as a function of the topology of the wireless network MN (e.g. its number of nodes), its environment (indoors, outdoors, in the presence of neighboring wireless networks), or the reception sensitivity of the nodes making up said wireless network MN.

In this way, it is possible to determine from the neighbor ratios and the threshold TH, for each node of the mesh network, whether it is within range of an executing node; then to establish a list of nodes that will be impacted by the transmissions of the executing node, and to deduce a list L_IMP of nodes impacted by the Wi-Fi Sensing action by uniting the lists of nodes impacted by the transmission of each executing node, here A and B. As previously described, this list L_IMP of impacted nodes is then used by device 100 to modify the configurations of all connections impacted by the scheduled Wi-Fi Sensing control action.

In relation to FIG. 9, a measured impact zone ZIA-ZID is shown for each node of the mesh network MN. This is measurable for each node, based on radio signal strength received information RSSI, which determines whether or not the node in question is within transmission range of another node.

In this example, we can deduce that:
a transmission from node A: impacts node B,
a transmission from node B: impacts nodes A, C and D,
a transmission from node C: impacts nodes B and E,
a transmission from node D: impacts node B,
a transmission from node E: impacts node C.

A bi-directional measurement transmission using the Wi-Fi Sensing procedure between nodes A and B will therefore impact the sum of their respective lists, i.e. L_IMP={B, A, C and D}.

This means that all links L2 established between nodes of the mesh network MN and comprising one of these four nodes will be impacted by the Wi-Fi Sensing procedure.

Accordingly, according to one or more embodiments, the device 100 is configured to request each of the nodes in the list L-IMP to modify its configuration in order to execute the Wi-Fi Sensing control action scheduled at nodes A and B.

Referring to FIG. 10, we now describe the message streams between the controller node CTR and the wireless network nodes MN that are impacted by a scheduled Wi-Fi Sensing network control action, according to one or more embodiments. It is assumed here that the device 100 has already carried out the impact study and that it has the list L_IMP of impacted nodes, for example stored in a memory of the device 100 or the controller node CTR.

The device 100 is configured to send (step 34) a first configuration modification request RQ1-RCFG to the nodes on the L_IMP list, in this case A, B, C and D, to ask them to remove the link L2 (which uses the 5 GHz frequency band) from their established connections with other nodes on the mesh network MN. For example, it sends a single message to all the nodes affected. Alternatively, it sends a message to each of the nodes affected.

On receipt, the device 200 of node A renegotiates the links to be used with node B so as to no longer use link L2{A,B} and to use links L1{A,B} and L3{A,B} instead. To do this, it applies a proprietary logic that can take into account the capacities of other available links and load-balancing constraints on these different links. In practice, each radio uses a different frequency band from the others, and the 2.4 GHz frequency band (L1) has significantly less capacity than the 5 GHz frequency band (L2), and even less than the 6

GHz frequency band (L3). In this case, the device 200 of node A decides to replace L2 with L3, which has the highest bandwidth.

According to one or more embodiments, the device 200 of node A sends (step 52) a connection renegotiation request RQ1_CNX to node APB, indicating that the links to be used are L1{A,B} and L3{A,B}. In other words, it has removed link L2{A,B} from the list of authorized links.

Likewise, the device 200 of node B renegotiates the links to be used with node C so as to no longer use link L2{B,C} and to use links L1{B,C} and L3{B,C} instead. To do so, according to one or more embodiments, the device 200 of node B sends (step 52) a connection renegotiation request RQ1_CNX to node C, indicating that the links to be used are L1{B,C} and L3{B,C}. In response, it receives an RP1_CNX acknowledgment message (not shown) from the node APC (step 53).

Likewise, the device 200 of node B also renegotiates the links to be used with node D so as to no longer use link L2{B,D} and to use links L1{B,D} and L3{B,D} instead. In response, it receives an RP1_CNX acknowledgment message (not shown) from the node D (step 53).

Likewise, the device 200 of node C renegotiates the links to be used with node E so as to no longer use link L2{C,E} and to use links L1{C,E} and L3{C,E} instead. In response, it receives an RP1_CNX acknowledgment message (not shown) from the node APE (step 53).

As for the device 200 of node D, it does not renegotiate any connections, as its link with node B has already been processed by node B.

Then, each of the nodes A, B, C and D acknowledges (step 54) the configuration change made in response to the RQ1-RCFG request to interrupt their respective link L2, for example by sending an acknowledgment message RP1_RCFG to the controller node CTR.

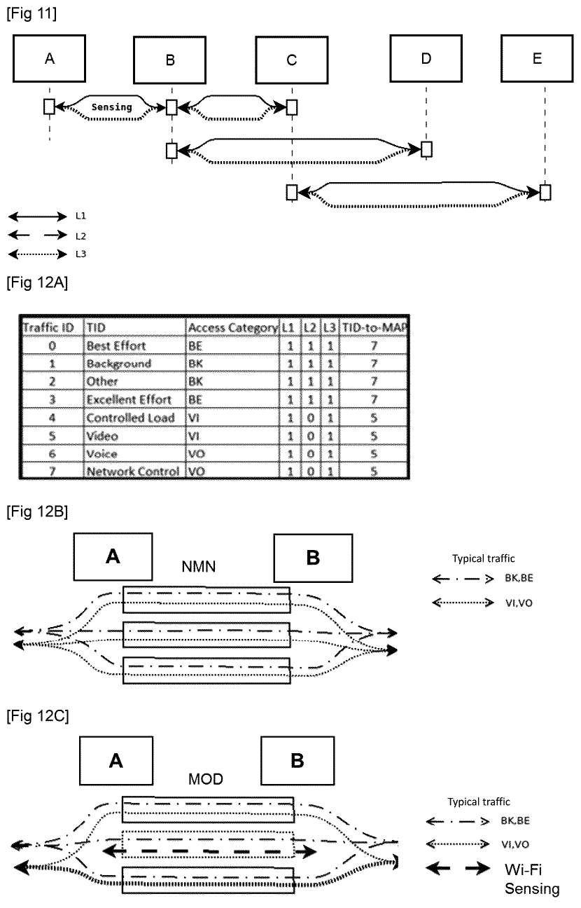

At this point, the renegotiated connections are configured as shown in FIG. 11:

### Between A and C:

A←→C(f1):L1{A,B}+L2{B,C}

A←→C(f2):L3{A,B}+L3{B,C}

A←→C(f3):L3{A,B}+L3{B,C}
Between A and D:

A←→D(f1):L1{A,B}+L1{B,D}

A←→D(f2):L1{A,B}+L1{B,D}

A←→AD(f3):L3{A,B}+L3{B,D}
Between A and E:

A←→E(f1):L1{A,B}+L1{B,C}+L1{C,E}

A←→E(f2):L3{A,B}+L3{B,C}+L3{C,E}

Once it has received (step 35) confirmation from each node in the list L_IMP that the configuration modification request RQ1_RCFG has been taken into account, the controller node triggers the execution of the scheduled Wi-Fi Sensing control action by sending an execution request RQ1_CA to node A.

Wi-Fi Sensing runs between nodes A and B for 10 seconds following the controller's request.

Once Wi-Fi Sensing has been performed, node A returns an acknowledgment message RP_CA, including a report on the execution of the Wi-Fi Sensing control action, to the controller node CTR.

Upon receipt of an end-of-execution notification (step 37), the controller node's device 200 sends (step 38) a second configuration modification request RQ2_RCFG to the affected nodes, asking them to re-establish the link L2 in their respective connections. To do this, it indicates, for example, that the L2 link is authorized. For example, it sends a single message to all the nodes affected. Alternatively, it sends a message to each of the nodes affected.

On receipt, node A renegotiates the links to be used with node B in order to use the link L2{A,B} again. To do so, according to one or more embodiments, the device 200 of node A sends (step 56) a connection renegotiation request RQ2_CNX to node B, indicating that the links to be used are L1{A,B}, L2{A,B} and L3{A,C}. In response, it receives an acknowledgment message RP2_CNX (not shown) from the node B (step 57).

Similarly, node B renegotiates the links to be used with C in order to use link L2{B,C} again.

Node B renegotiates the links to be used with D in order to use link L2{B,D} again.

Node C renegotiates the links to be used with E in order to use link L2{C,E} again.

Node D has no links to renegotiate.

Then, once their connections have been re-established, nodes A, B, C and D acknowledge the re-establishment of link L2 to the controller (step 58), for example by sending a message RP2_RCFG.

In relation to FIGS. 12A-12C, an example of a method for modifying a configuration of connections established by nodes of a wireless network according to another embodiment is now described. In this example, the solution based on the renegotiation of multi-link usage makes it possible to specify which types of traffic, that is, specific data streams, are authorized to use each of the links in the connection.

For example, the traffic types considered include background BK, best effort BE, video VI and voice VO. These different types of traffic are each associated with specific requirements in terms of transmission conditions. For example, data streams VI or VO are associated with “live” transmission conditions, and therefore with high latency and packet loss constraints.

According to the Wi-Fi standard and as shown in the table in FIG. 12A, these different stream types are associated with distinct traffic IDs. For example, type BE is associated with identifier value 0, type BK with value 1, type BE with value 3, type VI with value 5 and type VO with value 6.

In the following, the connection between A and B on the 2.4 GHz frequency band, allowing all types of traffic BK, BE, VI and VO, is denoted as follows: L1{A,B}[BK, BE, VI, VO]. If we remove the type VI data stream for this link, the notation becomes as follows: L1{A,B}(1)[BK, BE, VO].

In relation to FIG. 12B, in a nominal state NMN, it is assumed that all frequency bands can be used (in this case 2.4 GHZ, 5 GHZ and 6 GHZ) and that all links in a multi-link connection can accommodate all types of traffic. In other words, the multi-link connections established by the nodes in FIG. 1 are in this nominal state.

It is assumed, for example, that the control action CA scheduled on node PA in FIG. 1 is a Wi-Fi Sensing procedure on the frequency band used by link L2, and that the nodes impacted are those defined in connection with FIG. 9, that is, A, B, C and D. However, during the execution of the Wi-Fi Sensing procedure, the exchange of packets of data packets between A and B in the form of continuous transmission on the given frequency band, e.g. 5 GHz, may disrupt streams of type VI and VO, but streams of type BK and BE are not necessarily heavily impacted. In this case, it is a matter of renegotiating the use of the links to carry out a partial removal of the impacted L2 link, excluding the streams VI and VO.

More generally, it should be noted that the embodiment now described could be applied to any other control action that has the effect of disrupting the use of the given frequency band, but does not necessarily impose the total interruption of transmissions and receptions of data packets on the links using the given frequency band, in other words when the type of configuration modification T_MOD associated with the scheduled control action comprises a reduction of the connection on the impacted link.

According to this embodiment, the request to modify the configuration of the connection(s) sent to the impacted nodes of the wireless network MN (L_IMP) includes a notification to remove authorization to transmit and receive data on said impacted link for at least one type of data stream, but not for all types of data traffic. For example, it explicitly specifies that data traffic types VI and VO are not allowed to transit via the L2 link. For example, it can also specify that data traffic types VI and VO are to be routed via another link in the connection, for example link L3, whose frequency band is not subject to a scheduled control action.

In this way, a distinction is made between the types of traffic most heavily impacted (VI,VO), which are temporarily excluded from the L2 link and temporarily redirected to the L3 link.

Thus, for a multi-link data connection established by one of the nodes in the L_IMP list, the data stream paths are configured according to their traffic type, as follows:
BK, BE: Same status as the nominal status, that is, authorized on all links of the multi-link connection,
VI, VO: forbidden on link L2 and redirected to one of the other links.

According to the Wi-Fi standard, information authorizing the use of a type of traffic on a given link of a multi-link connection can be transmitted by the node that has established a multi-link connection with another node, to that other node, via an information element of a management frame message or Wi-Fi beacon sent periodically by the node in its local LAN to announce its capabilities, particularly in terms of QoS, but also a configuration to be adopted for stations wishing to connect to it. For each type of traffic, this information element specifies the authorized connection links.

For example, such an information element indicating the removal of type VI and VO traffic on the L2 link takes the following form:
Ext Tag: TID-To-Link Mapping (802.11be 03.0)
Ext Tag length 15 (Tag len: 16)
Ext Tag Number: TID-To-Link Mapping (802.11be3.0) (109)
TID-To-Link Mapping Control: 0x3a
Mapping Switch Time: 37607
Expected Duration: 6000
Link Mapping Of TID 0: 0x0007
Link Mapping Of TID 1: 0x0007
Link Mapping Of TID 2: 0x0007
Link Mapping Of TID 3: 0x0007
Link Mapping Of TID 4: 0x0005
Link Mapping Of TID 5: 0x0005
Link Mapping Of TID 6: 0x0005
Link Mapping Of TID 7: 0x0005

In relation to the table in FIG. 12A, we understand that the line “Link Mapping Of TID 5: 0x0005” is equivalent to authorizing type VI streams on links L1 and L3 and prohibiting them on link L2.

The solution proposed here is to use another type of TLV information field to specify the configuration modification request sent by the controller node to the node(s) impacted by the control action (TLV AP MLD Configuration Request and Response), for example an information field entitled “TID-to-Link Mapping Policy TLV” as described in the EasyMesh R6 standard, Section 17.2.102.

This other TID-To-Link Mapping Policy TLV information field has a similar structure to the previous one, except that it doesn't show a list of access points. Instead, it includes the TID-To-Link Mapping information just described for a Wi-Fi management frame.

Next, the 200 device of an impacted node is configured to trigger a renegotiation of the multi-link connections it has established with other nodes, which may be access points or stations, by sending them a connection renegotiation request, which may for example take the form of a generic message of the action frame type, comprising a TLV TID-to-Link Mapping element as described above. Indeed, it should be noted that the form of the TLV is the same for a modification request between the controller node and the agent of an impacted node, for example conforming to the EasyMesh protocol, and for a multi-link connection renegotiation request, conforming to the Wi-Fi standard between an impacted node and the stations or other access points connected to it.

In relation to FIG. 12C, the MOD state of the multi-link connection between nodes A and B is shown after the configuration change just described. VI and VO data streams no longer use link L2, but are redirected to link L3.

This alternative approach is advantageous in that it allows different configurations to be specified for different types of data traffic.

With reference to FIG. 13, we now describe an example of the hardware structure of devices 100 for controlling a configuration of a mesh network according to the invention and 200 for modifying a configuration of a multi-link connection between access points of a mesh network according to one or more embodiments of the invention.

In FIG. 13, the device 100, 200 comprises at least one processor 110, 210 and at least one memory 120, 220. The device 100, 200 may also comprise one or more communication interfaces. In this example, the device 100, 200 comprises network interfaces 130, 230 (for example, network interfaces for wired/wireless network access, including an Ethernet interface, WIFI interface, etc.) connected to the processor 110, 210 and configured to communicate via one or more wired/wireless communication links and user interfaces 140, 240 (for example, keyboard, mouse, display screen, etc.) connected to the processor. The apparatus 100 may also include one or more media players 150 for reading a computer-readable storage medium (for example, a digital storage disc (CD-ROM, DVD, Blue Ray, etc.), a USB stick, etc.). The processor 110, 210 is connected to each of the other aforementioned components in order to control their operation.

The memory 120, 220 may comprise random access memory (RAM), cache memory, non-volatile memory, backup memory (for example, programmable or flash memories), read-only memory (ROM), hard disk drive (HDD), solid-state drive (SSD) or any combination thereof. The ROM of memory 120, 220 can be configured to store, among other things, an operating system of the device 100, 200 and/or one or more computer program codes of one or more software applications. The RAM of memory 120 can be used by the processor 110, 210 for temporary data storage.

The processor 110, 210 can be configured to store, read, load, execute and/or otherwise process instructions stored in a computer-readable storage medium and/or in memory 120, 220 so that, when the instructions are executed by the processor, the device 100, 200 performs one or more or all of the steps of the control method, respectively the configuration modification method, described herein. Means implementing a function or a set of functions may also refer in this document to a software component, a hardware component or a set of hardware and/or software components, able to implement the function or the set of functions, as described below for the means concerned.

The present description also relates to an information medium readable by a data processor, and having instructions of a program as mentioned above. The information medium may be any hardware means, entity or device, capable of storing the instructions of a program as mentioned above. Usable program storage media include ROM or RAM memories, magnetic storage media such as magnetic disks and tapes, hard drives or optically readable digital data storage media, etc., or any combination thereof.

In some cases, the computer-readable storage medium is not transitory. In other cases, the information medium may be a transient medium (for example, a carrier wave) for the transmission of a signal (electromagnetic, electrical, radio or optical signal) carrying program instructions. This signal can be conveyed via an appropriate transmission medium, wired or wireless: electrical or optical cable, radio or infrared link, or by other means.

One embodiment also relates to a computer program product comprising a computer-readable storage medium having program instructions stored thereon, the program instructions being configured to cause the host device (for example a computer, or the device 100 of the controller node, or the device 200 of the impacted node) to implement some or all of the steps of one or more of the methods described herein when the program instructions are executed by one or several processors and/or one or more programmable hardware components of the host device, such as a controller node, respectively a node access point, of a mesh network.

The embodiments just presented are not limited to the particular example of a mesh network just presented, and they apply to other types of wireless communication networks whose nodes are each wireless network access points, such as, for example:
a wireless communication network structured according to another type of mesh besides the one described in relation to FIGS. 1 and 9, or a star-structured wireless communication network, according to which several nodes implementing the configuration modification method are connected to a single node (e.g. the controller node implementing the control method), or a wireless communication network supervised by a system of distributed controllers or by a remote controller hosted in a network featuring cloud computing architecture. The mechanisms just described apply in the same way,
a heterogeneous network, wherein some nodes implement the configuration modification method described above and others do not. In this case, a node that does not implement the proposed solution will not renegotiate its established connections with other nodes in the network, upon request from the controller node, before and after the execution of a scheduled control action.

The above-mentioned embodiments, and their variants, each offer a number of advantages. In particular, the proposed solution enables wireless network access point connected to each other by multi-link connections, to modify at an earlier stage and then restore at a later stage the configurations of their connections to avoid disruptions caused by a scheduled control action at one or more of these access point on a frequency band used by one of the links of the connections. The solutions offered by multiple embodiments work with standard IEEE 802.11 and EasyMesh messages as mentioned above.

1. A method for managing a configuration of a plurality of nodes of a wireless communication network (MN) controlled by a controller node (CTR), said nodes of the plurality of nodes being configured to establish between them connections, called multi-links, comprising at least two links using at least two distinct frequency bands, said method, implemented by a device for managing a configuration of a plurality of nodes of a wireless communication network, integrated with the controller node or connected to it by a communication interface, comprising the steps of:
obtaining information relating to a control action (CA) on one of said frequency bands, scheduled to be executed by at least one said node, referred to as the executing node, and likely to disrupt communications on one or more multi-link connections established between the executing node and one or more other nodes of the wireless communication network;
triggering the transmission, by the controller node, to at least one node, referred to as the impacted node, of the plurality of nodes, said at least one impacted node comprising said at least one executing node, and at least one other node of said plurality of nodes, with which said at least one executing node has established at least one multi-link connection, of which at least one link, referred to as the impacted link, uses said frequency band on which the control action is scheduled, of a request to modify the configuration of said at least one connection, for the impacted link, said configuration modification being a function of said control action and comprising a command to remove authorization to transmit and receive data on said impacted link for at least one type of data stream; and
upon receipt, from said at least one impacted node, of a confirmation of configuration modification of said at least one connection, transmitting information to said controller node indicating that said scheduled control action on said frequency band is ready to be executed.

2. The method according to claim 1, wherein it further comprises the steps of:
obtaining a report on the execution (RP_CA) of said control action (CA) on said frequency band, received by said controller node from said at least one executing node, and
transmitting said at least one impacted node a request (RQ2_RCFG) to restore the configuration of said at least one connection.

3. The method according to claim 1, wherein it comprises obtaining information relating to a type of configuration modification, at least as a function of the information relating to the control action, and
in that, when the information relating to a type of configuration modification comprises an interruption of data traffic on said impacted link, said command to remove authorization to transmit and receive data on said link affects all data stream types of the multi-link connection and, when the information relating to a type of configuration modification comprises a reduction in data traffic on said impacted link, said removal of authorization to transmit and receive data on said link does not affect all data stream types.

4. The method according to claim 1, wherein it further comprises obtaining a list (L_IMP) of said nodes impacted by said control action (CA), said list comprising said at least one executing node and at least one other node connected to said at least one node equipment by a multi-link connection comprising said impacted link, and in that the request for notification to modify the configuration of said link is issued to the impacted nodes of said list.

5. The method according to claim 1, wherein it further comprises the step of obtaining, from the plurality of nodes of said network, radio signal strength indications (RSSI) received from neighbor nodes, and in that the list of nodes impacted by said scheduled control action (CA) is determined at least from said received indications and from a minimum threshold (TH) of radio signal strength received.

6. The method for processing a request to modify a configuration of a node in a wireless communication network, said wireless communication network comprising a plurality of nodes, said nodes of the plurality of nodes being configured to establish between them so-called multi-link connections, comprising at least two links using at least two distinct frequency bands, said wireless communication network being controlled by a controller node (CTR), said method implemented by a device for processing a modification request integrated with said node, comprising the steps of:
receiving a request (RQ1_RCFG) to modify the configuration of said at least one multi-link connection, established by the node with at least one other node of said wireless communication network, transmitted by a controller node of said wireless mesh network, said request comprising a command to remove an authorization to transmit and receive data on the link using a given frequency band, for at least one type of data stream,
trigger the transmission by said node to said at least one other node of a first request (RQ1_CNX) to renegotiate said connection, implementing said command to remove authorization to transmit and receive data on said link for said at least one connection, for the at least one type of data stream, and
following the renegotiation of said connection, triggering the transmission, by said node, of a message comprising a report on the execution of the modification to the configuration of the controller node.

7. The method according to claim 6, wherein it further comprises the steps of:
receiving a request (RQ2_RCFG) to restore the configuration, from the controller node, said request comprising a command to add authorization to transmit and receive data on said link for said at least one connection, for said at least one type of stream,
triggering the transmission, by said node to at least one other node, of a second request (RQ2_CNX) to renegotiate said at least one connection, implementing the command to add authorization to transmit and receive data on said link for said at least one connection, for said at least one type of stream, and
triggering the transmission, by said node, of a message (RP2_RCFG) comprising a report on the restoration of the configuration of said at least one connection.

8. The device for managing a configuration of a plurality of nodes of a wireless communication network controlled by a controller node (CTR), said nodes of the plurality of nodes being configured to establish so-called multi-link connections between them, comprising at least two links using at least two distinct frequency bands, said device being integrated into the controller node or connected to it by a communication interface, said device comprising at least said communication interface, a memory and a processor connected to said at least one communication interface and to the memory to control its operation and configured to:
obtain information relating to a control action (CA) on one of said frequency bands, said control action being scheduled to be executed by at least one node in said network (MN), referred to as the executing node, and likely to disrupt communications on one or more multi-link connections established between the executing node and one or more other nodes of the wireless communication network;
trigger the transmission to at least one node, referred to as the impacted node, of the plurality of nodes, said at least one impacted node comprising said at least one executing node, and at least one other node of said plurality of nodes, with which the executing node has established at least one connection, of which at least one link, referred to as the impacted link, uses said frequency band on which the control action is scheduled, of a request to modify the configuration of said at least one connection, for the impacted link, said configuration modification being a function of said control action and comprising a command to remove authorization to transmit and receive data on said impacted link for at least one type of data stream; and
upon receipt, from said at least one impacted node, of a confirmation of configuration modification of said at least one connection, transmit information to said controller node indicating that said scheduled control action on said frequency band is ready to be executed.

9. The device for processing a request to modify a configuration of a node of a wireless communication network (MN) comprising a plurality of nodes connected to each other by connections referred to as multi-link connections comprising at least two links using distinct frequency bands, said network being controlled by a controller node (CTR), said node having established at least one connection with another node of said network, said device being integrated with said node, said device comprising at least one communication interface, a memory, and a processor connected to said at least one communication interface and to the memory to control its operation and configured to:
receive a request (RQ1_RCFG) to modify the configuration of at least one multi-link connection, for the link of said plurality of links using a given frequency band, transmitted by a management device according to claim 8 from a controller node of said wireless mesh network, said request comprising a command to remove authorization to transmit and receive data on said link for said at least one connection, for at least one type of data stream,
trigger the transmission, by said node to said at least one other node, of a first request (RQ1_CNX) to renegotiate said connection, implementing said command to remove authorization to transmit and receive data on said link for said at least one connection, for at least one type of data stream, and
following the renegotiation of said connection, trigger a transmission, by said node, of a message comprising a report on the execution of the modification to the configuration of the controller node.

10. An access point (A, B, C, D) to a wireless communication network forming a node of a wireless communication network (MN) comprising a plurality of nodes, said nodes of the plurality of nodes being configured to establish between them connections referred to as multi-link connections, comprising at least two links using distinct frequency bands, said node having established at least one said multi-link connection, comprising at least two links using the at least two distinct frequency bands, characterized in that it comprises a device for processing a configuration modification request according to claim 9.

11. The access point (A), referred to as the executing node, according to claim 10, wherein it is further configured to:
receive, from a controller node of said wireless communication network (MN), a command (RQ_CA) to perform a control action on one of said frequency bands,
following execution of the control action, issue an action execution report (RP_CA) to the controller node equipment.

12. A wireless communication network (MN) comprising a plurality of nodes, said nodes being access points according to claim 10 and at least one configuration management device.

13. A computer program comprising instructions for executing a method according to claim 1 when said program is executed by a computer.

14. A non-volatile, computer-readable recording medium, on which the computer program according to claim 13 is recorded.

15. A non-volatile, computer-readable recording medium, on which a computer program is recorded, said computer program comprising instructions for executing a method according to claim 1 when said program is executed by a computer.
